(19) United States
(12) Patent Application Publication
(10) Pub. No.: US 2017/0357903 A1
(43) Pub. Date: Dec. 14, 2017

(54) Prediction System for Geographical Locations of Users Based on Social and Spatial Proximity, and Related Method

(71) Applicant: Sysomos L.P., Toronto (CA)

(72) Inventors: Koushik PAL, Etobicoke (CA); Ousmane Amadou DIA, Toronto (CA); Kanchana PADMANABHAN, Toronto (CA)

(73) Assignee: Sysomos L.P., Toronto (CA)

(21) Appl. No.: 15/617,390

(22) Filed: Jun. 8, 2017

Related U.S. Application Data
(60) Provisional application No. 62/347,846, filed on Jun. 9, 2016.

(51) Int. Cl. G06N 5/02; G06N 5/04; G06Q 50/00

(52) U.S. Cl. CPC G06N 5/022; G06Q 50/01; G06N 5/04

(57) ABSTRACT

Determining a location of a user on a social network platform is difficult due to incorrect information or lack of information associated with the user. A system and method are provided to compute contextual similarity. This includes, for example, computing content similarity between seed users and followers/friends, as well as computing an engagement score between seed users and followers/friends. The system also computes geo-social-spatial similarity. The similarity scores are used in any inference computation to infer the geo-locations of the followers of the seed users, and subject users who share common friends with the seed users. The user geo-location inference database is updated using the result. Other seed users are selected, and the process is repeated.

### CROSS-REFERENCE TO RELATED APPLICATIONS

This application claims priority to U.S. Provisional Patent Application No. 62/347,846 filed on Jun. 9, 2016, entitled “Prediction System for Geographical Locations of Users Based on Social and Spatial Proximity, and Related Method” and the entire contents of which is incorporated herein by reference.

### TECHNICAL FIELD

The following generally relates to a prediction system for geographical locations of users based on social and spatial proximity, and related methods.

### DESCRIPTION OF THE RELATED ART

Location is one of the most important data tags used to direct computations, recommendations, information and services to specific user accounts or user devices. For example, geo-targeting in digital advertising allows for significant personalization and accurate measurement. In addition, with the huge increase in the number of wearable computing devices, geo-targeting has never been more powerful.

In traditional media, most geo-targeting is implicit. For example, if a person places an advertisement in a physical newspaper called the Toronto Star, only people in Toronto will see the advertisement. However, in digital media that assumption no longer holds true. Anyone with access to Internet can login to his/her social media account, thus making geo-location dynamic (as opposed to the traditional notion of static). There is also a one-to-many mapping from a person to geo-locations. In other words, people may be associated with multiple locations.

### BRIEF DESCRIPTION OF THE DRAWINGS

Embodiments will now be described by way of example only with reference to the appended drawings wherein:

FIG. 1 is an example of a social network graph comprising nodes and edges.

FIG. 2 is a system diagram including a server system in communication with other computing devices.

FIG. 3 is a schematic diagram showing another example embodiment of the server system of FIG. 2, but in isolation.

FIG. 4 is an example embodiment of a server system architecture, also showing the flow of information amongst databases and modules.

FIG. 5 is a flow diagram showing example executable instructions for inferring location based on geo-spatial similarity.

FIG. 6 is a flow diagram showing example executable instructions for inferring location based on geo-spatial similarity and contextual similarity.

FIG. 7 is a flow diagram showing example executable instructions for determining seed users and predicting the locations of interest of their followers.

FIG. 8 is a flow diagram showing example executable instructions for generating data comprising seeds with locations known with a high probability.

FIG. 9 is a flow diagram showing example executable instructions for using seeds to determine probable locations associated with followers of the seeds.

FIG. 10 is a table illustrating inference results from an example experiment.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

Geo-location (also called geographic location) for social media users has to be typically inferred as only a very small percentage of users disclose their location. For example, it is herein recognized that on the social data network called Twitter only 1.8% of users have specified their location out of which many are spurious.

Typically, geographically locating users revolves mainly around mapping users' Internet Protocol (IP) addresses to known or predicted locations. While this approach seems to work relatively well in e-commerce or social media environments, or for Internet service providers, companies that have secondary access to social data (e.g. lease the social data) however have either limited or no access at all to users IP addresses and other useful sign-ins information due to privacy reasons. This poses a significant technical challenge, and therefore renders the user geo-location inference task even harder.

Furthermore, it is herein recognized that IP addresses may be incorrect or may misrepresent a user due to IP routing and IP masking process provided by intermediary Internet services. Therefore, IP addresses, even if available, may not reflect the location of a user.

It is herein recognized that there are also different types of location associated with a user account, including Home Location, Current Location and Location(s) of Interest. The Home Location is a location that a user specifies while signing up (e.g. can be obtained from the user profile, such as Twitter user json). The Current Location is a location from which a user is currently sending a message (e.g. can be obtained from the user message if location services are activated, such as the Tweet jsons). The Location(s) of Interest are the locations of friends that a user follows (e.g. can be obtained from a Friends-Follower relationship graph). Identifying the true Home Location is very difficult, as users may prefer to purposely withhold this information.

It is herein proposed to infer geo-locations of social media users using self-disclosed locations of some users (herein referred to as seeds), social media relationships such as Follower and Friend, and the social media users content such as tweets, posts etc.

Below are some assumptions:

Geography, social relationship, and social contents are highly intertwined.

Relationships formed between people living in same geographical areas are carried over the Internet.

The geography and social environment that a person experiences dictates the online relationships he/she forms.

Social networking platforms include users who generate and post content for others to see, hear, etc (e.g. via a network of computing devices communicating through websites associated with the social networking platform). Non-limiting examples of social networking platforms are Facebook, Twitter, LinkedIn, Pinterest, Tumblr, blogospheres, websites, collaborative wikis, online newsgroups, online forums, emails, and instant messaging services. Currently known and future known social networking platforms may be used with principles described herein.

The term “post” or “posting” refers to content that is shared with others via social data networking. A post or posting may be transmitted by submitting content on to a server or website or network for other to access. A post or posting may also be transmitted as a message between two devices. A post or posting includes sending a message, an email, placing a comment on a website, placing content on a blog, posting content on a video sharing network, and placing content on a networking application. Forms of posts include text, images, video, audio and combinations thereof. In the example of Twitter, a tweet is considered a post or posting.

The term “follower”, as used herein, refers to a first user account (e.g. the first user account associated with one or more social networking platforms accessed via a computing device) that follows a second user account (e.g. the second user account associated with at least one of the social networking platforms of the first user account and accessed via a computing device), such that content posted by the second user account is published for the first user account to read, consume, etc. For example, when a first user follows a second user, the first user (i.e. the follower) will receive content posted by the second user. In some cases, a follower engages with the content posted by the other user (e.g. by sharing or reposting the content). A follower may also be called a friend.

In the proposed system and method, weighted edges or connections, are used to develop a network graph and several different types of edges or connections are considered between different user nodes (e.g. user accounts) in a social data network. These types of edges or connections include: (a) a follower relationship in which a user follows another user; (b) a re-post relationship in which a user re-sends or re-posts the same content from another user; (c) a reply relationship in which a user replies to content posted or sent by another user; and (d) a mention relationship in which a user mentions another user in a posting.

In a non-limiting example of a social network under the trade name Twitter, the relationships are as follows:

Re-tweet (RT): Occurs when one user shares the tweet of another user. Denoted by “RT” followed by a space, followed by the symbol @, and followed by the Twitter user handle, e.g., “RT @ABC followed by a tweet from ABC).

@Reply: Occurs when a user explicitly replies to a tweet by another user. Denoted by ‘@’ sign followed by the Twitter user handle, e.g., @username and then follow with any message.

@Mention: Occurs when one user includes another user's handle in a tweet without meaning to explicitly reply. A user includes an @ followed by some Twitter user handle somewhere in his/her tweet, e.g., Hi @XYZ let's party @DEF @TUV

These relationships denote an explicit interest from the source user handle towards the target user handle. The source is the user handle who re-tweets or @replies or @mentions and the target is the user handle included in the message. It will be appreciated that the nomenclature for identifying the relationships may change with respect to different social network platforms. While examples are provided herein with respect to Twitter, the principles also apply to other social network platforms.

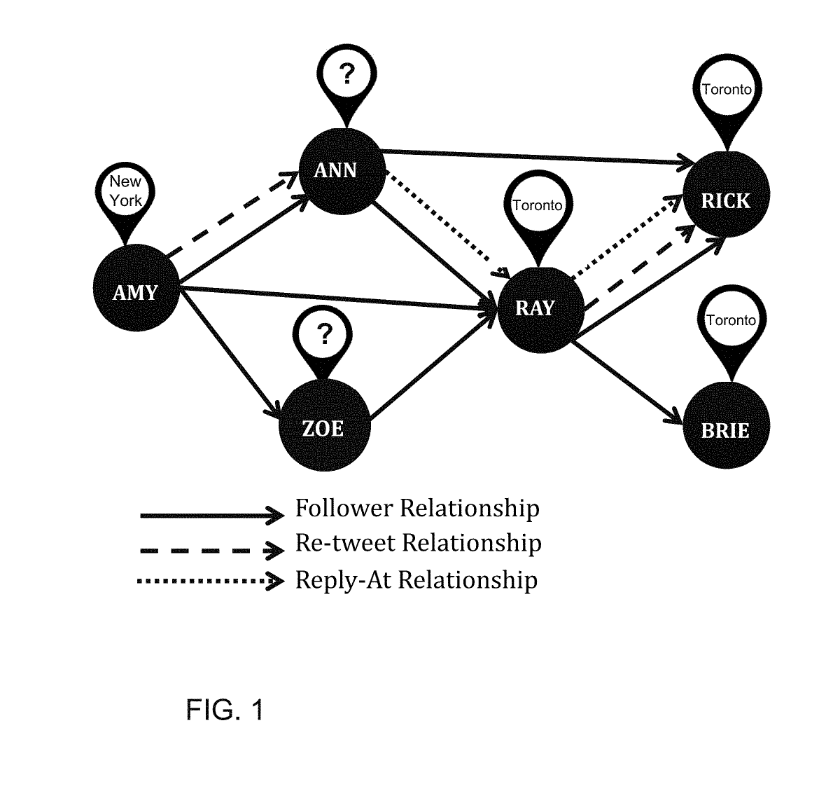

To illustrate the proposed approach, consider the network graph in FIG. 1, which depicts the user accounts of Ann, Amy, Ray, Zoe, Rick and Brie as nodes. Their relationships are represented as directed edges between the nodes. If Ray and Rick' geo-location information are known (e.g. physical location, latitude and longitude), then the system can infer Ann's location based on Ann's social relationship with Ray and Rick, and Ann's engagement (likes, re-tweets, shares, etc.) with Ray and Rick' posts. For that, the system first analyzes the similarity of Ann's tweets with tweets of Ray and Rick. This is herein called “textual similarity”. Then, the system computes the engagement score of Ann with respect to both Ray and Rick, based on her engagements to Ray and Rick posts. The “textual similarity” score combined with the “engagement score” of Ann and Ray (Rick) defines Ann's “contextual similarity” with Ray (Rick). Finally, as the system has already obtained Ray and Rick locations, the system can compute a spatial proximity between Ann and Rick, and Ann and Ray. To that end, the system first looks at friends that Ann and Rick (Ray) have in common, and segment them into buckets based on their locations. Using Ray' (Rick) latitude and longitude, the system determines the geographical area where Ray (Rick) and Ann common friends are most likely to live in. That generates the spatial proximity for Ann and Ray (Rick). Using the textual similarity, spatial proximity, and engagement scores, the system predicts the likelihood of Ann's location being either Rick or Ray's location.

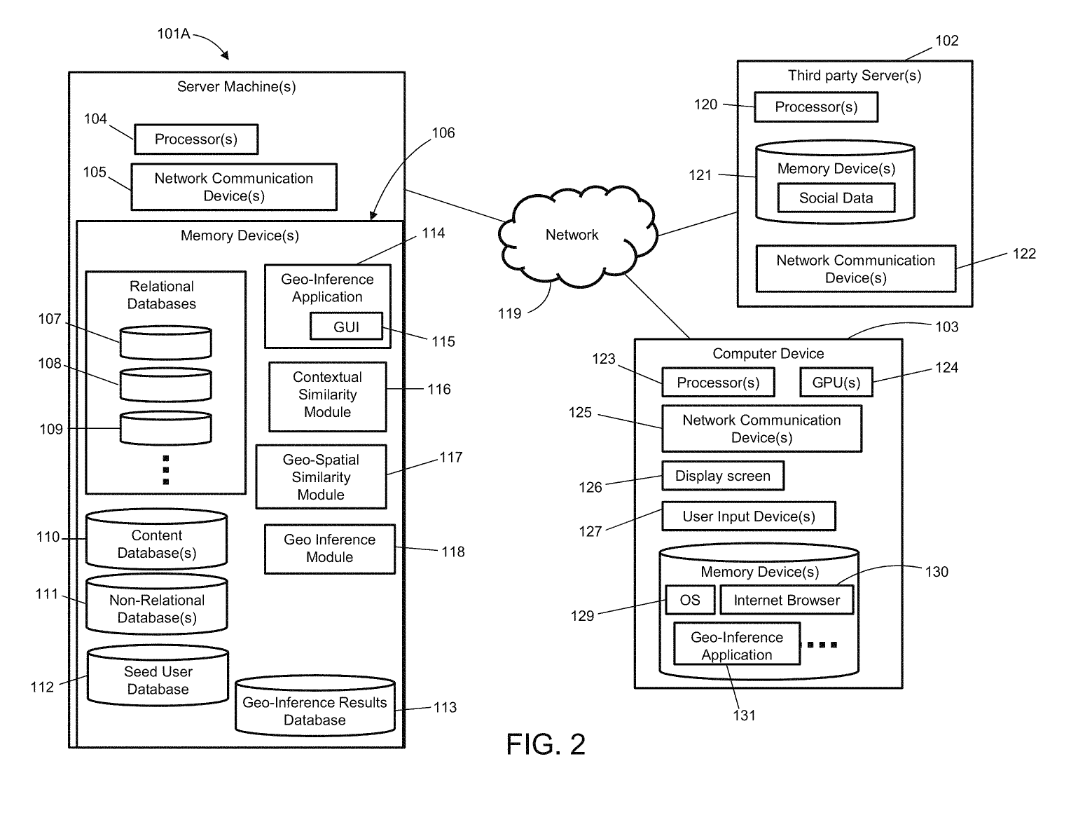

Turning to FIG. 2 an example embodiment of a server system 101A is provided for inferring geo-location of a user.

The server system 101A includes one or more processors 104. In an example embodiment, the server system includes multi-core processors. In an example embodiment, the processors include one or more main processors and one or more graphic processing units (GPUs). GPUs are typically used to process images (e.g. computer graphics), but they may also be used herein to process social data. For example, the social data is graph data (e.g. nodes and edges).

The server system also includes one or more network communication devices 105 (e.g. network cards) for communicating over a data network 119 (e.g. the Internet, a closed network, or both).

The server system further includes one or more memory devices 106 that store one or more relational databases 107, 108, 109 that map the activity and relationships between user accounts. The memory further includes a content database 110 that stores data generated by, posted by, consumed by, re-posted by, etc. users. The content includes text, images, audio data, video data, or combinations thereof. The memory further includes a non-relational database 111 that stores friends and followers associated with given users. The memory further includes a seed user database 112 that stores seed user accounts having known locations, and a geo-inference results database 113.

The memory 106 also includes a geo-inference application 114, a contextual similarity module 116, a geo-spatial similarity module 117, and a geo-inference module 118. In an example embodiment, the application 114 calls upon one or more of the modules 116, 117, and 118.

The server system 101A may be in communication with one or more third party servers 102 over the network 119. Each third party server having a processor 120, a memory device 121 and a network communication device 122. For example, the third party servers are the social network platforms (e.g. Twitter, Instragram, Snapchat, Facebook, etc.) and have stored thereon the social data, which is sent to the server system 101A.

The server system 101A may also be in communication with one or more user computer devices 103 (e.g. mobile devices, wearable computers, desktop computers, laptops, tablets, etc.) over the network 119. The computer device includes one or more processors 123, one or more GPUs 124, a network communication device 125, a display screen 126, one or more user input devices 127, and one or more memory devices 128. The computer device has stored thereon, for example, an operating system (OS) 129, an Internet browser 130 and a geo-inference application 131. In an example embodiment, the geo-inference application 114 on the server is accessed by the computer device 103 via the Internet Browser 130. In another example embodiment, the geo-inference application 114 is accessed by the computer device 103 via its local geo-inference application 131. While the GPU 124 is typically used by the computing device for processing graphics, the GPU 124 may also be used to perform computations related to the social media data.

It will be appreciated that the server system 101A may be a collection of server machines or may be a single server machine.

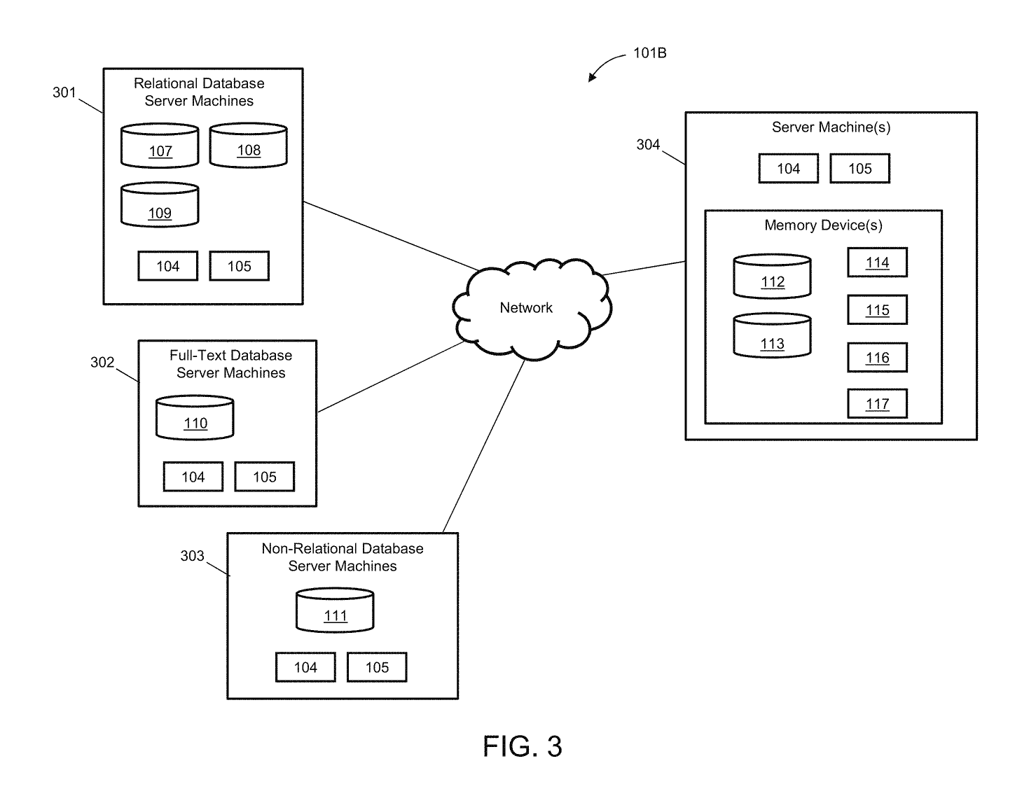

Turning to FIG. 3, an alternative example embodiment to the server system 101A is shown as multiple server machines in the server system 101B. The server system 101B includes one or more relational database server machines 301, that store the databases 107, 108 and 109. The system 101B also includes one or more full-text database server machines 302 that stores the database 110. The system 101B also includes one or more non-relational database server machines 303 that store the database 111. The system 101B also includes one or more server machines 304 that store the databases 112, 113, and the applications or modules 114, 115, 116, and 117.

It will be appreciated that the distribution of the databases, the applications and the modules may vary other than what is shown in FIGS. 2 and 3.

For simplicity, the example embodiment server systems 101A or 101B, or both, will hereon be referred to using the reference numeral 101.

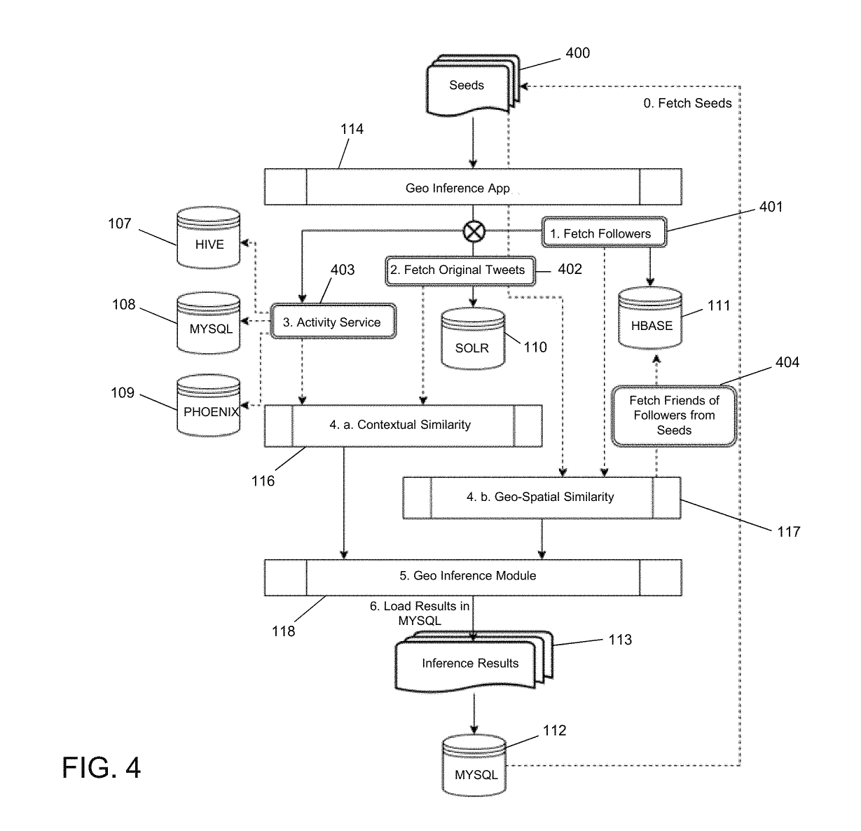

FIG. 4 shows an example architecture of the server system 101 and the flow of data amongst databases and modules.

As an initial step, the server system 101 obtains one or more seed user accounts (also called seeds or seed users) 400 from the database 112. In an example embodiment, the seed users accounts are those accounts in a social networking platform having known geographic locations. The database 112, for example, is a MYSQL type database.

The one or more seeds 400 are passed by the server system 101 into its geo inference application 114.

Responsive to receiving the seeds 400, the geo inference application 114 obtains followers (block 401) of one or more given seeds, and passes these followers to the geo-spatial similarity module 117. The followers, for example, are obtained by accessing the database 111, which for example is an HBASE database.

In this example implementation, an HBASE distributed Titan Graph database 111 runs on top of a Hadoop Distributed File System (HDFS) to store the social network graph (e.g., in a server cluster configuration comprising fifteen server machines). In other words, in an example implementation, the server machines 303 comprises multiple server machines that operate as a cluster.

The seeds 400 and the followers are passed to the geo-spatial similarity module 117, and in response the geo-spatial similarity module obtains common friends of each seed-follower pair (block 404).

The geo-spatial similarity module 117 computes one or more geo-spatial similarity scores between a given seed user account and a given subject user. A subject user herein refers to a user account that has an unknown location, or has one or more locations that are being verified. The subject user may also be a friend or follower of one or more of the seed users, and at the very least the subject user shares common friends or followers with one or more of the seed users. For example, in FIG. 1, Ann is the subject user, and Ray and Rick are seed users.

In the example embodiment, responsive to receiving the seeds 400, the application 114 further accesses the database 110 to obtain posts (e.g. Tweets) from the seed users and a given subject user, and passes these posts to the contextual similarity module 116 to compute a textual similarity score between the subject user and the one or more seed users. In an example embodiment, the text of the posts are compared to determine if the content produced by the users are the similar or relate to the same topics.

In another example embodiment, text, images, video, audio data, or combinations thereof are compared with each other to determine if the content is the same or relate to each other. For images and video data, this comparison includes pattern recognition and image processing. For audio data, this comparison includes pattern recognition and audio processing. The comparison process may also include using Deep Learning computations to obtain feature vectors, and to compare the feature vectors to each other.

In this example implementation, the content database 110 is a SOLR type database. SOLR is an enterprise search platform that runs as a standalone full-text server 302. It uses the Lucene Java search library as its core for full-text indexing and search.

Furthermore, responsive to receiving the seeds 400, the application 114 further accesses one or more of the relational databases 107, 108, 109 to determine the activity service of the seeds and the subject user. The activity service includes the replies, repost, posts, mentions, follows, likes, dislikes, etc. between the subject user and the one or more seed users, and is used by the contextual similarity module 116 to determine an engagement score.

In this example embodiment, the databases 107, 108, 109 are respectively a HIVE database, a MYSQL database and a PHOENIX database. HIVE is a data warehouse infrastructure built on top of Hadoop for providing data summarization, query, and analysis. MYSQL is a relational database management system. PHOENIX is a massively parallel, relational database layer on top of noSQL stores such as Apache HBase. Phoenix provides a Java Database Connectivity (JDBC) driver that hides the intricacies of the noSQL store enabling users to create, delete, and alter SQL tables, views, indexes, and sequences; upsert and delete rows singly and in bulk; and query data through SQL.

The contextual similarity module 116 computes a contextual similarity score using the engagement score. In another example embodiment, the contextual similarity score is computed using both the engagement score and the textual similarity score.

The contextual similarity module 116 passes the contextual similarity score to the geo inference module 118, and the geo-spatial similarity module 117 passes the geo-spatial similarity score to the module 118.

Responsive to receiving these scores, the geo-inference algorithm determines an inferred location of the subject user, and stores the inferred location result in the database 113.

The inferred location result may be used to update the locations of the subject user in other databases, including but not limited to the seed database 112.

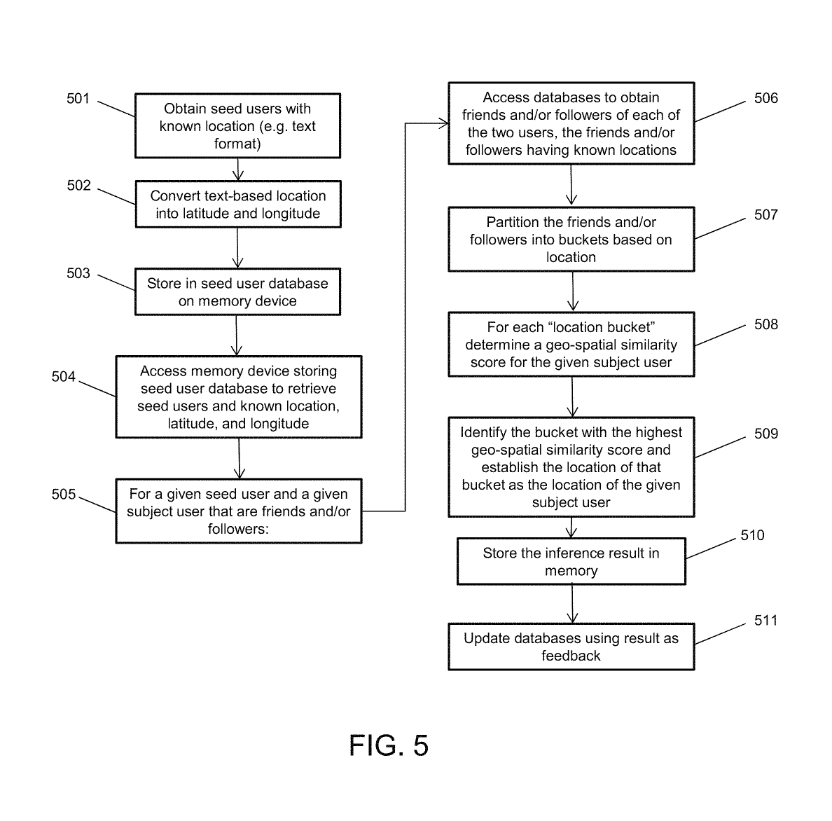

In an example embodiment, the server system 101 does not use the contextual similarity module 116, and relies on the computations and data related to the geo-spatial proximity similarity to infer the location of the subject user. Example executable instructions for this process are shown in FIG. 5.

In FIG. 5, at block 501, the server system 101 obtains seed users with known locations. The locations, for example, are represented as text (e.g. city, state, province, country, or combinations thereof) and are obtained from user account profiles on a social network platform.

At block 502, the server system 101 converts the text-based location into numerical data representing latitude and longitude coordinates. This numerical data is stored in the seed user database 112 in memory (block 503).

At block 504, the server system accesses the memory device that stores the seed user database 112 to retrieve and obtain seed users and their known latitude and longitude coordinates.

At block 505, the server system identifies a given seed user and a given subject user.

At block 506, the server system accesses the memory device storing the database 111 to obtain friends or followers, or both, that are common to both the given seed user and the given subject user.

At block 507, the server system partitions the friends or followers, or both, into buckets based on location. For example, there are: a “Toronto bucket”, a “Los Angeles bucket”, and a “New York bucket”.

At block 508, for each location bucket, the server system determines a geo-spatial similarity score for the given subject user. In other words, the subject user will have a geo-spatial similarity score for the Toronto bucket, a geo-spatial similarity score for the Los Angeles bucket and a geo-spatial similarity score for the New York bucket. The geo-spatial similarity score may be based on the number of friends or followers, or both, that the subject user has in a given location bucket. The geo-spatial similarity score, for example, is computed using the numerical distances between the seed user and the users in a given location bucket, and normalizing the value by the number of users within that location bucket. For example, when working with numerical distances, it is considered that if a subject user shares a lot of common friends with a seed user from a given location, then the subject user is most likely from the same geographic location as the seed user.

In another example embodiment, instead of a geo-spatial similarity score, the server system can use the information obtained from the location buckets to perform a K-Nearest Neighbor computation to directly identify the location of the subject user. In other words, the location of the subject user is classified based on its proximity to the K-nearest user accounts on a social graph, and the locations of those K-nearest user accounts. For example, the server system computes a linear combination of contextual similarity and social proximity of the subject user to the seed users on the social network graph, and executes a K-Nearest neighbour computation on that. It will be appreciated that K is a natural number.

The geo-social-spatial dimension allows the server system 101 to delimit the geographical area between any two users' known locations and thereby to determine how many of the two users' common followers/friends live within that delimited geographical area. The main idea here is that the likelihood of friendship with a person increases if that person and us have common friends that live in the same area. Conversely, this likelihood decreases with distance given that the further that distance is the less likely we are to interact with friends we have in common with that person. In other words, distance also affects the way that social relationship persists over time.

Continuing with FIG. 5, at block 509, the server system identifies the location bucket having the highest geo-spatial similarity score, and establishes the location of that location bucket as the location of the given subject user. For example, the Toronto bucket has the highest geo-spatial similarity score and therefore the server system establishes that Toronto is the inferred location of the subject user.

At block 510, server system stores the inference result (e.g. the inferred location) in memory. At block 511, the server system updates one or more databases using the inference result, for example, as feedback into the server system.

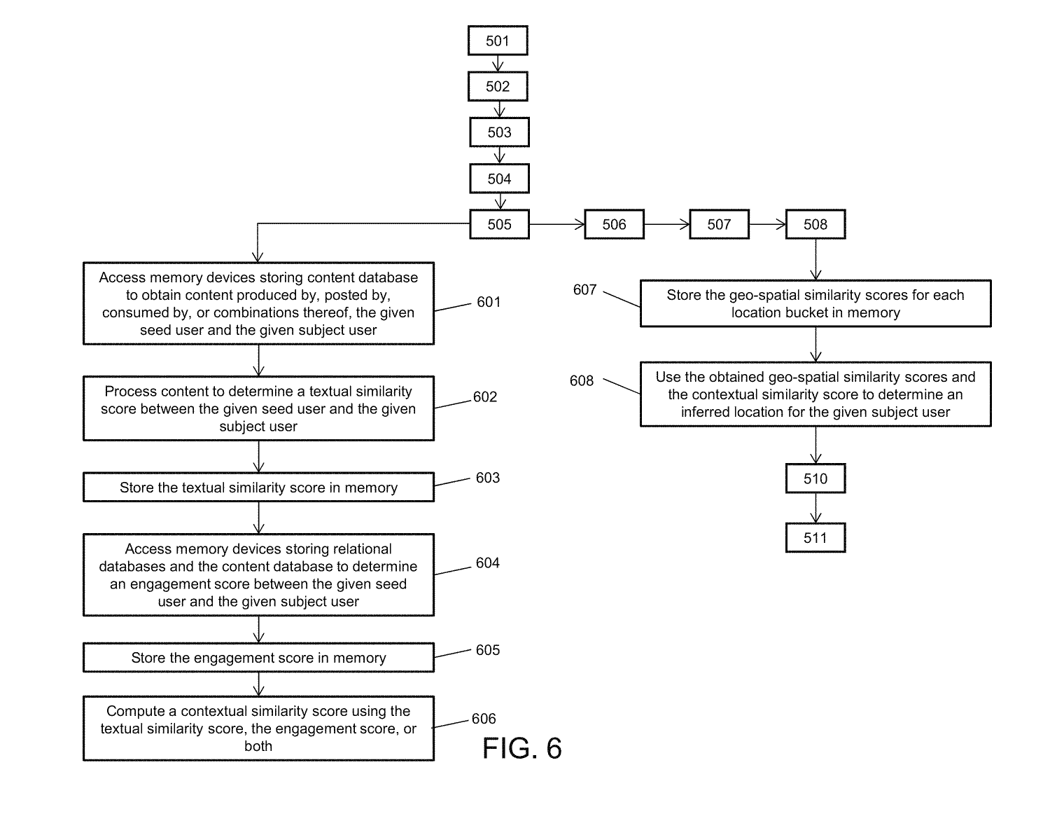

FIG. 6 shows example executable instructions for another example embodiment for inferring location of a subject user. This example includes computing and then utilizing the contextual similarity score.

The operations of blocks 501 to 508 are performed. At block 607, which follows block 508, the server system stores the geo-spatial similarity scores for the different location buckets in memory.

Following block 505, at block 601, the server system 101 also accesses the memory device storing the content database 110 to obtain content produced by, posted by, consumed by, or combinations thereof, the given seed user and the given subject user.

At block 602, the server system processes the content to determine a textual similarity score between the given seed user and the given subject user. For example, text from the posts in the database 110 are compared. Other types of comparisons may be made if the content is in other formats (e.g. images, video, audio, etc.). There are several ways to compute a textual similarity score. Two non-limiting examples are Levenshtein distance and mean squared error distance.

At block 603, the server system stores the textual similarity score in memory.

At block 604, the server system accesses the memory devices storing the relational databases 107, 108, 109 and the content database 110 to determine the activities amongst the users and to, therefore, determine an engagement score between the given seed user and the given subject user. In an example embodiment, the engagement score between a subject user and a seed user is computed as the total number of tweets of the seed user that are retweeted, @Mentioned or liked by the subject user divided by the total number of activities of the subject user on Twitter in a given time frame.

At block 605, the server system stores the engagement score in memory.

At block 606, the server system computes a contextual similarity score using the textual similarity score or the engagement score, or both. In an example embodiment, only the engagement score is used to compute the contextual similarity score.

At block 608, which follows block 607 and block 606, the server system uses the obtained geo-spatial similarity scores and the contextual similarity score to determine an inferred location for the given subject user. For example, the K-nearest neighbor is used to determine the location. In another example embodiment, the geo-spatial similarity scores are used to weight the edges between the subject user and the one or more seed users. In an example embodiment, for a given subject user, a final similarity score to every seed user is computed as a linear combination of the contextual score and the social proximity between the two, and then K-nearest neighbour is executed by the server system on the resulting weighted graph to find the seed user that is closest to the given subject user. The location of that seed user is prescribed as the most probable location of the given subject user.

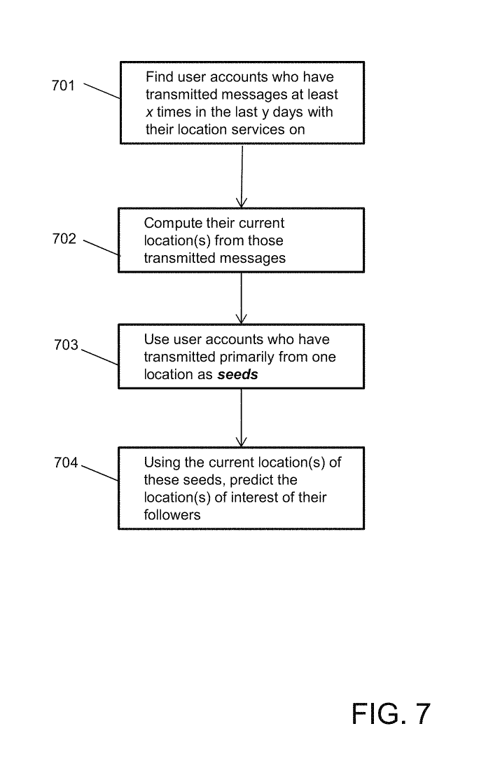

Turning to FIG. 7, another example embodiment of executable instructions is provided. At block 701, the server system finds user accounts who have transmitted messages at least x times in the last y days with their location services on. It will be appreciated that x and y are natural numbers. These messages, for example, are tweets. At block 702, the server system computes their current location(s) from those transmitted messages. At block 703, the server system uses user accounts who have transmitted primarily from one location as the seeds. At block 704, the server system uses the current location(s) of these seeds to predict the location or locations of interest of one or more of the seeds' followers.

It will also be appreciated that the operations of blocks 701 to 704 may be performed as part of block 501.

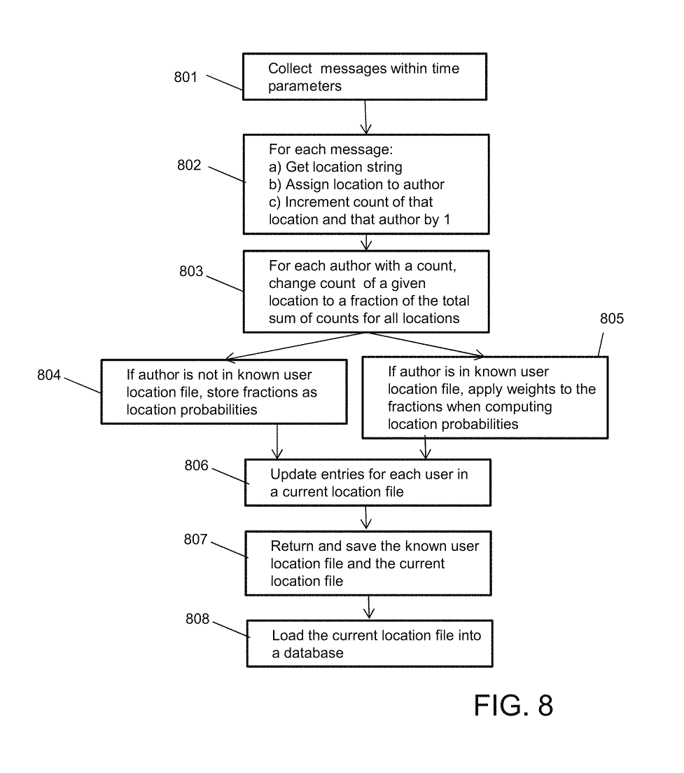

Another example embodiment of executable instructions for identifying seed users is shown in FIG. 8 and discussed further below. This example is specific to Twitter, but may also be applied to other social data networks or platforms. In particular, the computing process generates a list of seeds whose geographic locations are known (with high confidence).

Step 1 (block 801): Go through the Twitter data for the past D (e.g., D=30) days and get tweets with location from the twitter API (if it exists). Collect all such tweets/retweets.

Step 2 (block 802): For each tweet/retweet found in (step 1):
a) Get location string, latitude and longitude and maintain GEO_COORD file:
   i LOCATION, LATITUDE, LONGITUDE, COUNT (count: number of times that one location appeared, and it is used to compute average of lat and long when updating this table)
b) Assign that location to the author of the tweet/retweet and increment the count of that location for that author by 1. Also maintain a list of such authors.

Step 3: For each author A found in (step 2b):
a) (block 803) Change the user's counts to frequencies by dividing by the total sum. For example, if A has San Francisco 20 times, Los Angeles 10 times and Berkeley 30 times in the author's list, change them to ⅓ for San Francisco, ⅙ for Los Angeles and ½ for Berkeley.
b) (block 804) If author A does not occur in the USER_LOCATION file, store these final fractions as the probabilities that A is from the corresponding geographic location in the USER_LOCATION file in the following json format:

```
{
  ID: TwitterID of author a
  Location: The most likely location of author a
  Probabty: Probability that a is from Location
  NumberOfTweets: Number of tweets obtained for author a
  Places: [{Key: Location, Value: Probability that A is from
  Location}]
}
```

c) (block 805) If author A exists in the USER_LOCATION file, multiply the author's existing probabilities by β (e.g., β=0.3) and his current probabilities by 1−β, and store the final results back in the table. This is done to give more weightage to current data as opposed to previous data for each user.
d) (block 806) Also maintain CURRENT_LOCATION file based on the USER_LOCATION file:
   i. For each User:
      1. Sort the Places Array by Probability of each location in descending order.
      2. Assign a rank for each location, and get a COUNT (how many tweets that support this location, where COUNT=Probability*NumberOfTweets)
      3. Save each location as a row in CURRENT_LOCATION table in the following format:
   (ID, RANK, LOCATION, PROBABILITY, COUNT)

Step 4 (block 807): Return and save the USER_LOCATION and CURRENT_LOCATION files.

Step 5 (block 808): Load CURRENT_LOCATION into Database (e.g. the PHOENIX database), and then delete CURRENT_LOCATION file.

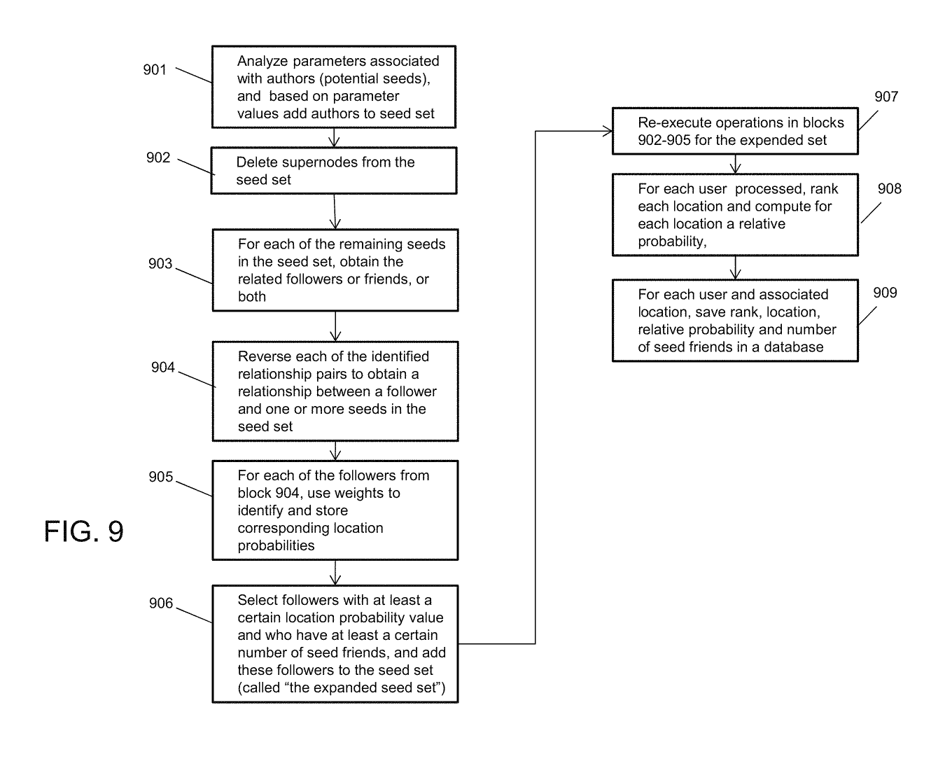

After the process of FIG. 8, the computing process shown in FIG. 9 is used, for example, to get the most likely geographic locations of as many Twitter users as possible, starting from a given list of seeds whose geographic locations are known.

Therefore, turning to FIG. 9, the following instructions that are executable by the server system are provided.

Step 1 (block 901): If the highest probability of A's being at any place is greater than γ₁ (e.g., γ₁=0.79) and A has more than T (e.g., T=10) tweets in the USER_LOCATION file, add A to the seed set S.

Step 2 (block 902): Delete the supernodes from the list of seeds. This can be done by looking up the seeds in the Supernodes table (e.g. stored in the MySQL database). Typically, supernodes are those nodes that have lots of followers. Non-limiting examples include Justin Bieber's Twitter user account, or the U.S. President's Twitter user account. In an example embodiment, supernodes are nodes that have more than 10 million followers.

Step 3 (block 903): For all the remaining seeds, get all <Seed, Follower of that seed>relationships by accessing a database (e.g. the HBase database).

Step 4 (block 904): Reverse all the relationship pairs to get FOLLOWER_TO_SEEDS pairs <Follower, List of Seeds>. In an example embodiment, the purpose of reversing the SeedToFollower list to the FollowerToSeed list is to be able to compute the location probabilities of each follower from the information of their seed friends in an independent and parallel way. For example, the computation is done via Spark, a trade name for a cluster computing framework.

Step 5 (block 905): For each FOLLOWER_TO_SEEDS u, execute the following:
1. Define sᵤ:=1/number of seed friends of U.
2. For each seed friend v of u, get all the geographic locations of v, and assign them to u with a weight of sᵤ times the corresponding weights for v and a count of 1.
3. Store these final fractions as probabilities and the final counts as number_of_supporting_seeds that u is from the corresponding geographic locations in the USER_INFERRED_GEO.

Step 6 (block 906): Seed Expansion: For all followers of all seeds for whom the server system have predicted their geographic locations in steps 1-5, determine the ones for whom the highest probability of being at any place is greater than γ₂ (e.g., γ₂=0.69) and who have at least L (e.g., L=5) seed friends, and add them to the seed set (also called the “Expanded seed set”).

Step 7 (block 907): For all users in Expanded seed set, execute the operations in steps 2-5.

Step 8 (block 908): For each user the server system have thus processed do the following:
1. Sort all the locations in Locations array by probability in descending order.
2. Remove all the locations that has probability less than 0.01.
3. Assign each location a rank and compute its relative probability (relative_ probability=probability of that location/the max probability in the array)
4. Compute K such that for every index <=K, probability[index]<=2.5*probability[index 1].
5. Save each location with rank <=K as a row in GEO_RESULT file in the following format:
   ID, RANK, LOCATION, RELATIVE_PROB, NUM_OF_SEED_FRIENDS

Step 9 (block 909): Load GEO_RESULT into Database (PHOENIX), and then delete GEO_RESULT file.

Using the operations in FIGS. 8 and 9, for example, the server system is able to find the (most probable) geographic location (a city, a state, or a country) of as many Twitter users as possible. In other words, the server system uses the geographic locations of the friends of a user on Twitter to predict the user's most probable geographic location. For example, if the user has 50% of her friends living in location A, 30% of her friends in location B and 20% in location C, then the server system will compute a prediction value indicating that the geographic location of the user to be location A with probability 50%, location B with probability 30%, and location C with probability 20%. To do this effectively, the server system first determines related user accounts, such as friends, followers, etc., which are the seed user accounts that have a lot of geo-tagged tweets/retweets. The server system also determines the geographic locations of these seed user accounts with high confidence.

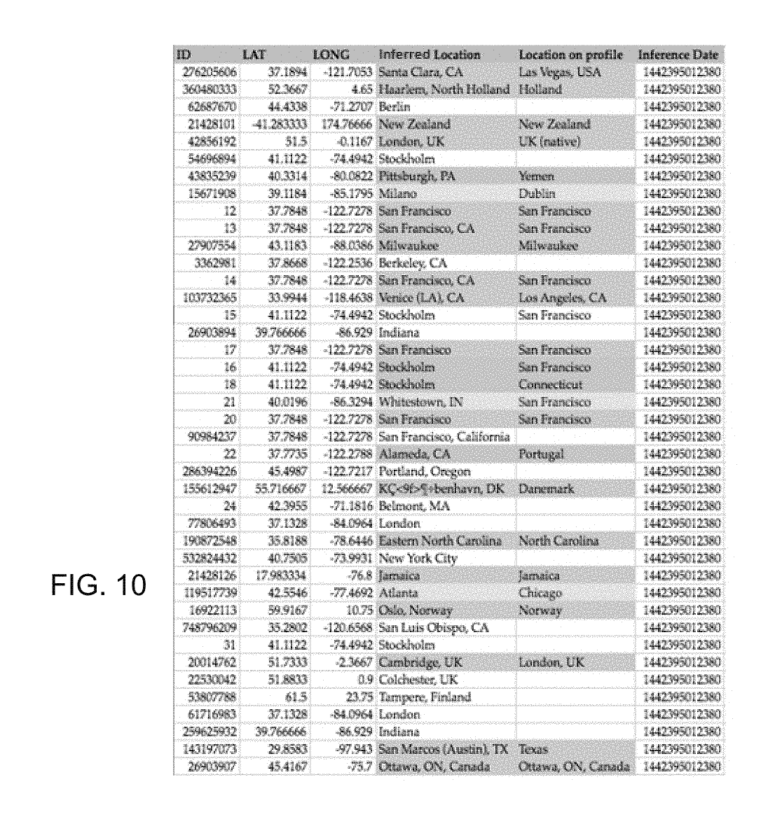

In an example experiment, the server system was provided with an input comprising a dataset of 2900 Twitter users with known physical locations (e.g. latitude and longitude). In the table shown in FIG. 10, the results are shown. In particular, the inference results include an ID representing the user account, latitude and longitude numerical coordinates representing the inferred location, a text value representing the inferred location which is obtained from the latitude and longitude coordinates, the location of the user accounts profile which may not always be available or accurate, and the inference date that indicates when the inference result was determined by the server system 101. To evaluate the accuracy of the approach, the server system compared the inferred locations of the users with the locations they disclosed in their Twitter profiles. As can be seen in the table, a good number of the users didn't disclose their locations. In this experiment, we restrict our evaluation to only the users who disclosed their locations. At the country level, the server system obtained an accuracy of 86% for the 26 users presented, and 61.5% of the locations of the users the server system inferred correspond exactly to the locations these users disclosed in their profiles. There were also cases when the locations that were inferred were different from the locations disclosed in some of the users profiles but after exploring the tweets, followers, and friends of these users, it was clear that the inferred locations were accurate.

It will be appreciated that the systems and methods described herein do not need to use IP addresses, or to access servers storing IP addresses, in order to obtain location data. In some cases where IP addresses are inaccurate or do not correctly represent a user, then the systems and methods described herein are able to still accurately infer a user's location.

The systems and methods described herein rely on the social network relationship data stored in the databases, which are more readily available and accessible.

The systems and methods described herein also may be used to continuously (e.g. the processes are performed repeatedly). In this way, the server system is able to identify that a subject user has moved or changed location, even if the subject user's profile has not been updated to reflect their new location. For example, the server system stores a date tag associated with each inference result in the database 113. The server system uses the date tag to compare how the inference results for a given subject user change or remains the same over time. For example, temporary changes in location may be filtered out.

Furthermore, in cases when a subject user has listed on their profile multiple locations, the server system is able to identify the primary location for the subject user.

In a general example embodiment, a system and method are provided to compute contextual similarity. This includes, for example, computing content similarity between seed users and followers/friends, as well as computing an engagement score between seed users and followers/friends. The system also computes geo-social-spatial similarity. The similarity scores are used in any inference computation to infer the geo-locations of the followers of the seed users, and subject users who share common friends with the seed users. The user geo-location inference database is updated using the result. Other seed users are selected, and the process is repeated.

Below are additional general example embodiments and related aspects.

In a general example embodiment, a server system for inferring a location for a subject user is provided. It includes: a communication device configured to communicate with a data network; one or more memory devices storing a seed user database, a database storing friends and followers of users within a social data network, and a geographic inference application; and one or more processors. These one or more processors are configured to at least: access the one or more memory devices to obtain from the seed user database a seed user having a known location in text format; use the geographic inference application to convert the known location into numerical coordinates; access the one or more memory devices to identify, from the database storing friends and followers of users, friends and followers common to both the seed user and a subject user, the subject user having an unknown location and the friends and followers having known locations; use the geographic inference application to partition the friends and followers into location buckets; for each location bucket, use the geographic inference application to determine a geo-spatial similarity score; use the geographic inference application to identify the location bucket with a highest geo-spatial similarity score and establish the location of that location bucket as an inferred location of the subject user; and store the inferred location in the one or more memory devices.

In an example aspect, the one or more processors are further configured to populate the seed user database by at least: identifying user accounts in the social data network that have transmitted messages at least x times in the last y days with their respective location service activated, where x and y are natural numbers; identifying a subset of the user accounts that each one have transmitted a majority of messages in the last y days from one respective location; and storing the subset of the user accounts as seed users.

In another example aspect, the one or more processors are further configured to populate the seed user database by at least: computing multiple probabilities respectively associated with multiple locations, the multiple locations associated with a given user account, and the multiple probabilities including a highest probability associated with a certain one of the multiple locations; responsive to determining that the highest probability is above a threshold probability, storing the given user account and the certain one of the multiple locations in the seed user database.

In another example aspect, the seed user database includes multiple seed users, including the seed user and supernode seeds, wherein the supernode seeds have more than a threshold number of followers, and the one or more processors are configured to delete the supernode seeds from the seed user database.

In another example aspect, the database storing friends and followers of users is an HBASE database implemented on multiple server machines that operate as a cluster.

In another example aspect, the one or more processors are configured to compute each one of the known locations of the friends and followers independently and in parallel using a cluster computing framework.

In another example aspect, the inferred location is stored with a date tag, and subsequent inferred locations associated with the subject user are stored with respective date tags.

In another example aspect, the geo-spatial similarity score is computed using at least numerical distances between the seed user and each of the friends and followers in a given location bucket, and a number of the friends and followers in the given location bucket.

In another general example embodiment, a server system for inferring a location for a subject user is provided. The server system includes: a communication device configured to communicate with a data network; one or more memory devices storing at least a seed database and a database storing a graph network of followers of users in a social data network, and a geographic inference application; and one or more processors. These one or more processors are configured to at least: find user accounts in a social data network that have transmitted messages at least x times in the last y days, each of the messages having location data; compute current locations from the messages; store the user accounts that have transmitted the majority of the messages from one location as seeds in the seed database; access the seed database and the database storing the graph network to retrieve the current locations of the seeds and subsequently compute the locations of the followers of the seeds.

In an example aspect, the location data comprise text data of a city name, or country name or both, and the computed current locations comprise numeric latitude and longitude coordinates.

In another example aspect, the database storing the graph network of followers is an HBASE database implemented on multiple server machines that operate as a cluster.

In another example aspect, the seed user database includes multiple seeds, including supernode seeds, wherein the supernode seeds have more than a threshold number of followers, and the one or more processors are configured to delete the supernode seeds from the seed user database, and remaining seeds in the seed user database are used to compute the locations of the followers of these remaining seeds.

In another example aspect, the one or more processors are configured to compute the locations of followers of the seeds independently and in parallel using a cluster computing framework.

In another example aspect, each of the locations of the followers of the seeds are stored with a date tag, and subsequent computed locations of the same followers are stored with respective date tags.

In another example aspect, the one or more processors are configured to use the date tags of a given follower to determine if the given follower's location changes over time or remains the same.

In another example aspect, temporary changes in the given follower's location are filtered out.

In another general example embodiment, one or more non-transitory computer readable mediums are provided that store a seed user database, a database storing friends and followers of users within a social data network, and a geographic inference application. The one or more non-transitory computer readable mediums further include executable instructions for inferring a location for a subject user, and the executable instructions, when executed, causing a server system to at least: obtain from the seed user database a seed user having a known location in text format; use the geographic inference application to convert the known location into numerical coordinates; identify, from the database storing friends and followers of users, friends and followers common to both the seed user and a subject user, the subject user having an unknown location and the friends and followers having known locations; use the geographic inference application to partition the friends and followers into location buckets; for each location bucket, use the geographic inference application to determine a geo-spatial similarity score; use the geographic inference application to identify the location bucket with a highest geo-spatial similarity score and establish the location of that location bucket as an inferred location of the subject user; and store the inferred location.

In another general example embodiment, one or more non-transitory computer readable mediums are provided that store at least a seed database and a database storing a graph network of followers of users in a social data network, and a geographic inference application. The one or more non-transitory computer readable mediums further include executable instructions for inferring a location for users in a social data network, and the executable instructions, when executed, causing a server system to at least: find user accounts in the social data network that have transmitted messages at least x times in the last y days, each of the messages having location data; compute current locations from the messages; store the user accounts that have transmitted the majority of the messages from one location as seeds in the seed database; and access the seed database and the database storing the graph network to retrieve the current locations of the seeds and subsequently compute the locations of the followers of the seeds.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the computing systems described herein or any component or device accessible or connectable thereto. Examples of components or devices that are part of the computing systems described herein include server machines and computing devices. Any application or module herein described may be implemented using computer readable/executable instructions that may be stored or otherwise held by such computer readable media.

It will be appreciated that different features of the example embodiments of the system and methods, as described herein, may be combined with each other in different ways. In other words, different devices, modules, operations and components may be used together according to other example embodiments, although not specifically stated.

The steps or operations in the flow diagrams described herein are just for example. There may be many variations to these steps or operations without departing from the spirit of the invention or inventions. For instance, the steps may be performed in a differing order, or steps may be added, deleted, or modified.

Although the above has been described with reference to certain specific embodiments, various modifications thereof will be apparent to those skilled in the art without departing from the scope of the claims appended hereto.

1. A server system for inferring a location for a subject user, the server system comprising:
a communication device configured to communicate with a data network;
one or more memory devices storing a seed user database, a database storing friends and followers of users within a social data network, and a geographic inference application;
one or more processors configured to at least:
access the one or more memory devices to obtain from the seed user database a seed user having a known location in text format;
use the geographic inference application to convert the known location into numerical coordinates;
access the one or more memory devices to identify, from the database storing friends and followers of users, friends and followers common to both the seed user and a subject user, the subject user having an unknown location and the friends and followers having known locations;
use the geographic inference application to partition the friends and followers into location buckets;
for each location bucket, use the geographic inference application to determine a geo-spatial similarity score;
use the geographic inference application to identify the location bucket with a highest geo-spatial similarity score and establish the location of that location bucket as an inferred location of the subject user; and
store the inferred location in the one or more memory devices.

2. The server system of claim 1 wherein the one or more processors are further configured to populate the seed user database by at least: identifying user accounts in the social data network that have transmitted messages at least x times in the last y days with their respective location service activated, where x and y are natural numbers; identifying a subset of the user accounts that each one have transmitted a majority of messages in the last y days from one respective location; and storing the subset of the user accounts as seed users.

3. The server system of claim 1 wherein the one or more processors are further configured to populate the seed user database by at least: computing multiple probabilities respectively associated with multiple locations, the multiple locations associated with a given user account, and the multiple probabilities including a highest probability associated with a certain one of the multiple locations; responsive to determining that the highest probability is above a threshold probability, storing the given user account and the certain one of the multiple locations in the seed user database.

4. The server system of claim 1 wherein the seed user database includes multiple seed users, including the seed user and supernode seeds, wherein the supernode seeds have more than a threshold number of followers, and the one or more processors are configured to delete the supernode seeds from the seed user database.

5. The server system of claim 1 wherein the database storing friends and followers of users is an HBASE database implemented on multiple server machines that operate as a cluster.

6. The server system of claim 1 wherein the one or more processors are configured to compute each one of the known locations of the friends and followers independently and in parallel using a cluster computing framework.

7. The server system of claim 1 wherein the inferred location is stored with a date tag, and subsequent inferred locations associated with the subject user are stored with respective date tags.

8. The server system of claim 1 wherein the geo-spatial similarity score is computed using at least numerical distances between the seed user and each of the friends and followers in a given location bucket, and a number of the friends and followers in the given location bucket.

9. A server system for inferring a location for a subject user, the server system comprising:
a communication device configured to communicate with a data network;
one or more memory devices storing at least a seed database and a database storing a graph network of followers of users in a social data network, and a geographic inference application;
one or more processors configured to at least:
find user accounts in a social data network that have transmitted messages at least x times in the last y days, each of the messages having location data;
compute current locations from the messages;
store the user accounts that have transmitted the majority of the messages from one location as seeds in the seed database;
access the seed database and the database storing the graph network to retrieve the current locations of the seeds and subsequently compute the locations of the followers of the seeds.

10. The server system of claim 9 wherein the location data comprise text data of a city name, or country name or both, and the computed current locations comprise numeric latitude and longitude coordinates.

11. The server system of claim 9 wherein the database storing the graph network of followers is an HBASE database implemented on multiple server machines that operate as a cluster.

12. The server system of claim 9 wherein the seed user database includes multiple seeds, including supernode seeds, wherein the supernode seeds have more than a threshold number of followers, and the one or more processors are configured to delete the supernode seeds from the seed user database, and remaining seeds in the seed user database are used to compute the locations of the followers of these remaining seeds.

13. The server system of claim 9 wherein the one or more processors are configured to compute the locations of followers of the seeds independently and in parallel using a cluster computing framework.

14. The server system of claim 9 wherein each of the locations of the followers of the seeds are stored with a date tag, and subsequent computed locations of the same followers are stored with respective date tags.

15. The server system of claim 14, wherein the one or more processors are configured to use the date tags of a given follower to determine if the given follower's location changes over time or remains the same.

16. The server system of claim 15, wherein temporary changes in the given follower's location are filtered out.

17. One or more non-transitory computer readable mediums that store a seed user database, a database storing friends and followers of users within a social data network, and a geographic inference application, the one or more non-transitory computer readable mediums further comprising executable instructions for inferring a location for a subject user, the executable instructions, when executed, causing a server system to at least:
obtain from the seed user database a seed user having a known location in text format;
use the geographic inference application to convert the known location into numerical coordinates;
identify, from the database storing friends and followers of users, friends and followers common to both the seed user and a subject user, the subject user having an unknown location and the friends and followers having known locations;
use the geographic inference application to partition the friends and followers into location buckets;
for each location bucket, use the geographic inference application to determine a geo-spatial similarity score;
use the geographic inference application to identify the location bucket with a highest geo-spatial similarity score and establish the location of that location bucket as an inferred location of the subject user; and
store the inferred location.

18. One or more non-transitory computer readable mediums that store at least a seed database and a database storing a graph network of followers of users in a social data network, and a geographic inference application, the one or more non-transitory computer readable mediums further comprising executable instructions for inferring a location for users in a social data network, the executable instructions, when executed, causing a server system to at least:
find user accounts in the social data network that have transmitted messages at least x times in the last y days, each of the messages having location data;
compute current locations from the messages;
store the user accounts that have transmitted the majority of the messages from one location as seeds in the seed database;
access the seed database and the database storing the graph network to retrieve the current locations of the seeds and subsequently compute the locations of the followers of the seeds.
